(19) United States
(12) Patent Application Publication
(10) Pub. No.: US 2002/0002479 A1
(43) Pub. Date: Jan. 3, 2002

(54) Career management system

(76) Inventors: Gal Almog, Rosh-Haayin (IL); Daniel A. Vidor, Rosh-Haayin (IL)

Correspondence Address: William H. Dippert, Esq., c/o Cowan, Liebowitz and Latman, P.C., 1133 Avenue of the Americas, New York, NY, 10036-6799, US

(21) Appl. No.: 09/742,687

(22) Filed: Dec. 20, 2000

(30) Foreign Application Priority Data
Dec. 20, 1999 (IL) 133617

(51) Int. Cl. G06F 17/60

(52) U.S. Cl. 705/8

(57) ABSTRACT

A method of job placement. The method includes storing a database including a plurality of records of worker profiles, providing a description of a job opening, storing the description of the job opening in a job opening database, and automatically determining by a processor, for at least one of the records in the worker database, whether the worker profile in the record matches the description of the job opening.

### FIELD OF THE INVENTION

The present invention relates to methods of providing employment information and particularly to on-line automatic systems for providing career management services and employment information.

### BACKGROUND OF THE INVENTION

Job hunting and recruiting is a problematic and time consuming task. Many companies need to find highly qualified workers within very short periods. For this purpose conventional ads are not usually sufficient. Employment agencies maintain databases of people looking for jobs. However, these databases are usually of limited scope. Therefore, in many cases employment agencies deal with recruiting workers which are not included in their database responsive to specific requests of employers for workers.

Many Internet sites provide information on job openings, e.g., www.careermosaic.com. These sites, however, are usually only an electronic version of conventional want ads. Some web sites, such as Bid4geeks.com and Talent Market, post employees for auction, inviting employers to bid for the employees.

An employment agency at www.careercentral.com allows online job recruiters to fill out questionnaires describing their professional profiles. Likewise employers seeking workers may fill out questionnaires on-line.

A web site, at careerbuilder.com, allows users to search for job offers of a specific position which are above a minimal salary.

One of the major tools in luring workers is offering high salaries. Of course, employers prefer not to offer too high a salary unnecessarily. Workers, on the other hand, wish to receive as high a salary as possible. One of the methods to know how high a salary to offer or accept is by comparing to other workers in similar positions.

Some web sites, such as www.informationweek.com/itsalsryadvisor and wwwjobsmart.com, provide salary surveys based on professions and experience. These surveys are usually based on a relatively small number of surveyed companies and/or workers, and are updated only every few months.

### SUMMARY OF THE INVENTION

An aspect of some embodiments of the invention relates to managing an on-line, widely available database of employment related information which is continuously updated in real time.

The use of a real time database has the advantage of providing important real time data on available workers as this data is accumulated. In the real time database, only a short period (e.g., of the order of seconds) occurs between entering information and using that information in providing query results.

In some embodiments of the invention, a running query may be left at the database, such that each new record which fulfills the query is brought to the immediate attention of the user who provided the query. Thus, a worker may leave an open query for the average compensation of a given profile and receive updates when the compensation he/she is actually getting is substantially lower than the going average. In addition, an employer may provide a running query for workers such that each new worker preparing a record which fits the query is immediately brought to the attention of the employer and/or the employer's job opening is immediately brought to the attention of the worker.

In some embodiments of the invention, the queries provided by the users are used in building the database. Many queries require entering, for example, a worker profile to which the query relates. The data entered for the query is optionally used in building a record of the database.

The use of a real time database also helps in convincing people to enter information into the database. The ability to receive information substantially at the same time the information is being acquired is an incentive for people to enter the information. A person connecting to the database to receive information is usually more willing to provide information than a person who needs to provide information without receiving information. In some embodiments of the present invention, only people who provide information to the database are allowed to query the database.

The use of an on-line database allows users to provide sequences of queries which depend on the results of each other. For example, if too many records are received in response to a query, the query may be narrowed by the user, to receive a smaller number of records which fulfill the query. In another example, a user may provide sequences of queries which check the affect of changes in the user's expertise on the compensation the user receives.

The database optionally includes records on current employment and compensation of workers. Optionally, the database also includes for at least some of the records information on desired positions and/or compensations for which the workers are willing to accept a new position.

In some embodiments of the invention, the database may be queried for records which describe workers who fulfill a desired profile. A company performing the query may approach these workers and offer them jobs. Optionally, the database may be queried for employment related information based on records which match a certain profile. The employment related information may include an average salary rate for the profile, suggested methods of increasing the salary and/or methods for reaching a desired salary. Alternatively or additionally, the employment information includes information on the popularity of specific job titles and/or worker profiles as well as the percentage of persons in the population who may fill specific job openings.

An aspect of some embodiments of the present invention relates to automatic matching of workers and employers without human intervention. By managing an on-line real time database, employers can find a predetermined number of workers which most closely fit their needs without manually scrutinizing large numbers of worker profiles.

Optionally, workers and employers may specify criterions of the jobs and workers they are looking for and thus avoid scrutinizing large lists of jobs and/or worker profiles.

There is therefore provided in accordance with an embodiment of the present invention, a method of job placement, including storing a database including a plurality of records of worker profiles, providing a description of a job opening, storing the description of the job opening in a job opening database, and automatically determining by a processor, for at least one of the records in the worker database, whether the worker profile in the record matches the description of the job opening. Optionally, storing the database includes receiving information for at least some of the records over a network which connects a plurality of remote processors. Optionally, providing the description of the job opening includes providing the description over a network which connects a plurality of remote processors.

Optionally, storing the database includes storing a database in which at least some of the records include a salary received by the worker represented by the record. Alternatively or additionally, storing the database includes storing records which include values for a predetermined set of fields and providing the description of the job opening includes providing values for the predetermined set of fields. Optionally, providing the description of the job opening includes providing range values for one or more of the fields and/or stating an importance of one or more of the fields. Optionally, determining whether the worker profile matches the job opening includes assigning each field a score and generating a total matching score from a weighted sum of the scores of the fields. Optionally, determining for at least one of the records whether the worker profile of the record matches the job opening includes determining which of a plurality of the records match the job opening. Optionally, the method includes providing a list of the workers represented by the matching records to an employer. Optionally, the method includes selecting by the employer workers who are of interest to the employer, and indicating to the workers that they have been selected by the employer. Optionally, indicating to the workers includes marking a job opening record of the employer with a special indication in displaying search results of the job opening database to the worker. Alternatively or additionally, indicating to the workers includes sending a message to the workers. Optionally, the method includes determining one or more attributes which differentiate between the matching records. Optionally, the method includes displaying a graph which shows an average salary of the matching records depending on the one or more attributes. Optionally, the method includes counting the matching records. Optionally, the method includes determining an average salary of the matching records.

Optionally, determining for at least one of the records whether the worker profile of the record matches the job opening includes selecting a predetermined number of records which most closely fit to the job opening description. Alternatively or additionally, determining for at least one of the records whether the worker profile of the record matches the job opening includes setting a similarity range to the job opening description such that records falling in the similarity range are considered matching the job opening.

Optionally, providing a different description of a job opening responsive to the determination and repeating the determining with the provided different description. Optionally, the descriptions of the job openings include a plurality of fields and the different description of a job opening is different from the previously provided description in substantially only one field. Optionally, automatically providing by the processor suggested changes in the description of the job opening such that the description matches a desired set of one or more records. Optionally, providing the suggested changes includes providing changes which match records with an average salary higher than an average salary of records matching the provided description without the changes, by a required percent. Optionally, the method includes displaying data from one or more worker records which were determined to match the job opening description. Optionally, at least one of the one or more worker records from which data was displayed was stored in the worker database only a short period before the automatic determination. Optionally, the method includes notifying the workers represented by the one or more records from which data was displayed that the data was displayed.

There is further provided in accordance with an embodiment of the present invention, a system for job placement, including a memory which stores a plurality of records of worker profiles, a network interface which receives a record describing a job opening from a network which connects a plurality of remote processors, and a processor which compares the received job opening record to one or more of the worker profile records in the memory.

Optionally, the processor selects worker records which match the job opening record.

Optionally, the job opening record includes a plurality of requirements and the processor selects worker records which fit all the requirements of the job opening record. Alternatively, the processor selects worker records which fit at least a predetermined percent of the requirements of the job opening record. Optionally, the processor selects a predetermined number of worker records which most closely match the job opening record. Optionally, the processor assigns substantially each of the worker records with a matching score which indicates the extent to which the worker record matches the job opening record.

Optionally, the job opening record includes a plurality of requirements and in assigning the matching scores the processor assigns each of the requirements with a weight indicative of the importance of the requirement in assigning the matching scores. Optionally, the processor calculates an average salary of the selected worker records. Alternatively or additionally, the processor suggests changes in the job opening record which would result in a job opening record which would match records which have a predetermined attribute. Optionally, the predetermined attribute includes an average salary higher than the average salary of the selected worker records by at least a given percent. Optionally, the processor sends messages to workers represented by the selected worker records notifying them of the job opening. Optionally, at least some of the worker records in the memory are received through the network interface. Optionally, the system includes a second memory in which the received job opening records are stored. Optionally, worker records received through the interface are stored in the memory and may be compared by the processor to the received job opening record immediately upon reception.

There is further provided in accordance with an embodiment of the present invention, a method of establishing an opinion on a worker profile, including receiving a worker profile, comparing the received worker profile to a database of a plurality of worker profiles, and automatically generating by a processor, responsive to the comparison, an opinion on the received worker profile. Optionally, receiving the worker profile includes receiving over a network which connects a plurality of remote processors. Optionally, generating the opinion includes generating an opinion on a salary level of the worker profile. Alternatively or additionally, generating the opinion includes generating a career plan for an owner of the worker profile. Further alternatively or additionally, generating the opinion includes suggesting one or more subjects to be studied. Further alternatively or additionally, generating the opinion includes stating salary levels for several values of a field of the worker profile which achieve highest salary levels among the possible values of the field. Optionally, the method includes displaying the opinion within a short period from receiving the worker profile. Optionally, generating the opinion is performed based on one or more records of the worker database which were stored in the worker database only a short period before receiving the worker profile. Optionally, the method includes periodically generating a follow up opinion and notifying the owner of the worker profile when the follow up opinion has results substantially different than previously generated opinions.

There is further provided in accordance with an embodiment of the present invention, a method of job placement, including storing a database including a plurality of records of job openings, providing a description of a worker, storing the description of the worker in a worker database, and automatically determining by a processor, for at least one of the records in the job opening database, whether the job opening in the record matches the worker description.

Optionally, the automatic determination is performed based on one or more records of the job opening database which were stored in the job opening database only a short period before providing the worker description. Optionally, the method includes displaying data from one or more records of the job opening database which were determined to match the worker description. Optionally, the data from the one or more records is displayed together with indication of the attitude of the employers of the one or more records toward the worker description. Optionally, the indication of the attitude of the employer includes indication of whether the description of the worker fits to the job opening in the respective record and/or whether the description of the worker was viewed by the employer. Optionally, the worker description includes a salary range desired by the worker.

### BRIEF DESCRIPTION OF THE DRAWINGS

The invention will be more clearly understood by reference to the following description of embodiments thereof in conjunction with the figures, wherein identical structures, elements or parts which appear in more than one figure are labeled with the same or similar numeral in all the figures in which they appear, in which:

FIG. 1 is a schematic illustration of a system for providing employment information, in accordance with an embodiment of the invention;

FIG. 2 is a schematic block diagram of the contents and services provided by the system of FIG. 1, in accordance with an embodiment of the present invention.

FIG. 3 is a flowchart of the actions performed by a user accessing the system of FIG. 1, in accordance with an embodiment of the present invention;

FIG. 4 is a schematic illustration of a user interface for receiving information for an employment database, in accordance with an embodiment of the present invention; and

FIG. 5 is a schematic illustration of a user interface for career planning, in accordance with an embodiment of the present invention.

### DETAILED DESCRIPTION OF EMBODIMENTS

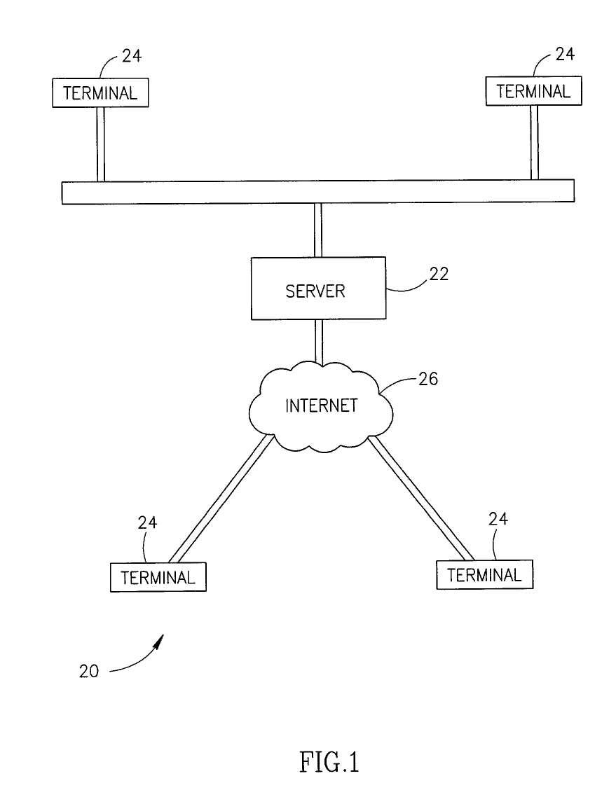

FIG. 1 is a schematic illustration of a system 20 for managing employment information, in accordance with an embodiment of the invention. System 20 comprises a server 22 which manages a database of employment information. Optionally, a plurality of remote terminals 24 connect to server 22 over a public network 26, such as the Internet. Alternatively or additionally, some of terminals 24 connect to server 22 over a private or dedicated network.

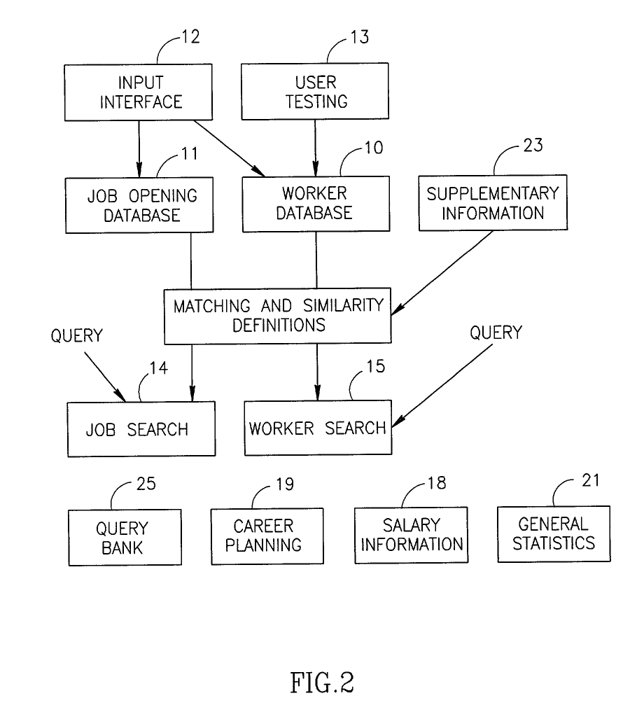

FIG. 2 is a schematic block diagram of the contents and services provided by server 22, in accordance with an embodiment of the present invention. Server 22 optionally carries one or more databases of employment related information. In some embodiments of the invention, server 22 carries a worker database 10 and a job opening database 11. An input interface 12 is used by users to enter information to databases 10 and 11. In addition, an on-line user testing unit 13 may be invoked by users to perform psychometric tests, language tests and/or other employment related tests, the results of which are stored in the user's record of worker database 10. Alternatively or additionally, server 22 provides on-line courses and/or connects users to on-line courses of other servers. Upon graduation of an on-line course, the worker's record in database 10 is optionally automatically updated.

Users connecting to server 22 may search databases 11 and 10 for job openings and workers, respectively, using search engines 14 and 15. In addition, users may invoke procedures for requesting employment related information, such as a procedure for requesting salary information of specific worker profiles 18, a procedure for career planning 19 and/or a procedure for general statistics 21. Server 22 optionally includes definitions 16 of which records in the same database are considered similar (e.g., the largest distance between two records which are still similar), and of which records of one database are considered matching records of the other database. In some embodiments of the invention, server 22 includes an open query bank 25 in which users leave queries which are evaluated periodically by server 22 as new records enter the database. In some embodiments of the invention, each record in databases 10 and/or 11 serves as an open query for respective jobs and workers who fit the record.

In some embodiments of the present invention, server 22 comprises a supplementary information database 23 which has information which helps in performing record comparisons. The supplementary information includes, for example, geographical information used to determine distances between cities, currency information to compare salaries in different currencies, tuition fees and ratings of education institutes. Alternatively or additionally to storing the supplementary information in server 22, the server consults other Web sites which carry the required supplementary information.

Databases 10 and 11 are optionally connected on-line to terminals 24 and are updated in real time. Thus, as described below, information added to a database at a specific time may be used already a short period (e.g., a few seconds) later in generating responses to user queries by server 22.

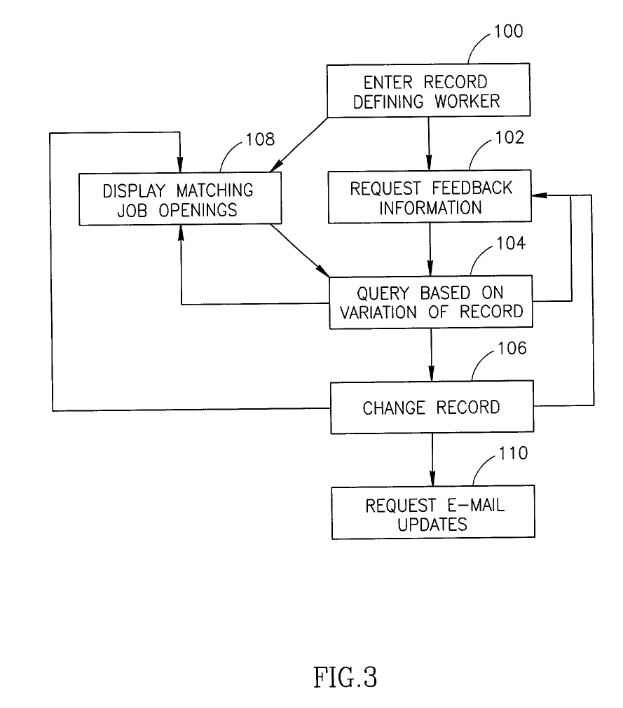

FIG. 3 is a flowchart of the actions performed by a user accessing server 22, in accordance with an embodiment of the present invention. The user optionally enters (100) through interface 12 a record containing a worker profile describing the user, or other worker. Responsive to the entered record, the user may request from server 22 to search the job opening database and display (108) a listing of job openings which match the entered profile. Optionally, the worker may also request that server 22 provide (102) feedback on the record, such as an opinion on the salary which should be paid to the worker, suggestions on courses worthwhile to be learnt by the worker and/or a career plan.

Upon receiving the feedback and/or the job opening listings the worker may request (104) feedback and/or additional job openings based on one or more variations of the entered record, e.g., “what if” questions. For example, the user may query for a deserved salary of the worker and/or for job openings if the worker had more experience or worked in a different location.

In some embodiments of the present invention, the user may amend (106) the record responsive to the feedback and/or listed job openings.

In some embodiments of the invention, the user may leave (110) in query bank 25 delayed queries to be evaluated by server 22 periodically even when the user is not connected to the server. The results of the delayed queries are optionally sent to the user via e-mail (external or internal to server 22), a real time banner and/or any other messaging method. Alternatively or additionally, the user is notified that new results have been determined and is invited to connect to server 22 to see the results. In some embodiments of the invention, the results are sent to the user only if they fulfill an interest criterion set by the user. For example, a delayed query may request notification when the average salary in records similar to the user's profile increases by more than 10% relative to the salary of the user and/or relative to the answer to the query as received on the last time the user connected to server 22.

In some embodiments of the invention, server 22 periodically evaluates all the delayed queries in bank 25 from scratch. Alternatively, server 22 stores along with each delayed query in bank 25, fields summarizing the results of the query, and for each addition, deletion and/or change in a record of one of databases 10 and 11 the result fields are updated as necessary.

In some embodiments of the invention, the user may request (110) that matching job openings and/or worker profiles entered to the database at later times be brought to his/her immediate attention. In some embodiments of the invention, entering a record to worker database 10 is an implicit request to receive updates on available job openings. Alternatively or additionally, the worker may indicate how eager he/he is to receive job offers on a multi-level scale (e.g., no job-offers, curious, interested, looking although employed, unemployed).

The speed at which the information is brought to the user optionally depends on the payments of the user. In some embodiments of the invention, an e-mail message or a real time banner is sent to the user with the description of the job. Alternatively or additionally, the message states that a new opening awaits the user at server 22. Further alternatively or additionally, a message is sent periodically to the user (e.g., every week) stating the number of additional jobs which match the user's record.

In some embodiments of the present invention, when an employer views a worker profile in database 10 indication is sent to the worker who entered the profile. Optionally, the indication indicates the level of interest the employer showed, for example by stating whether the profile was found similar to a job-opening posted by the employer, whether the employer indicated he/she was interested in the worker, and/or how much time the employer spent viewing the details of the worker. Optionally, database 10 stores for each worker record a listing of the number of employers who showed interest in the profile of the worker. Employers querying database 10 may search for workers who, for example, have high interest levels.

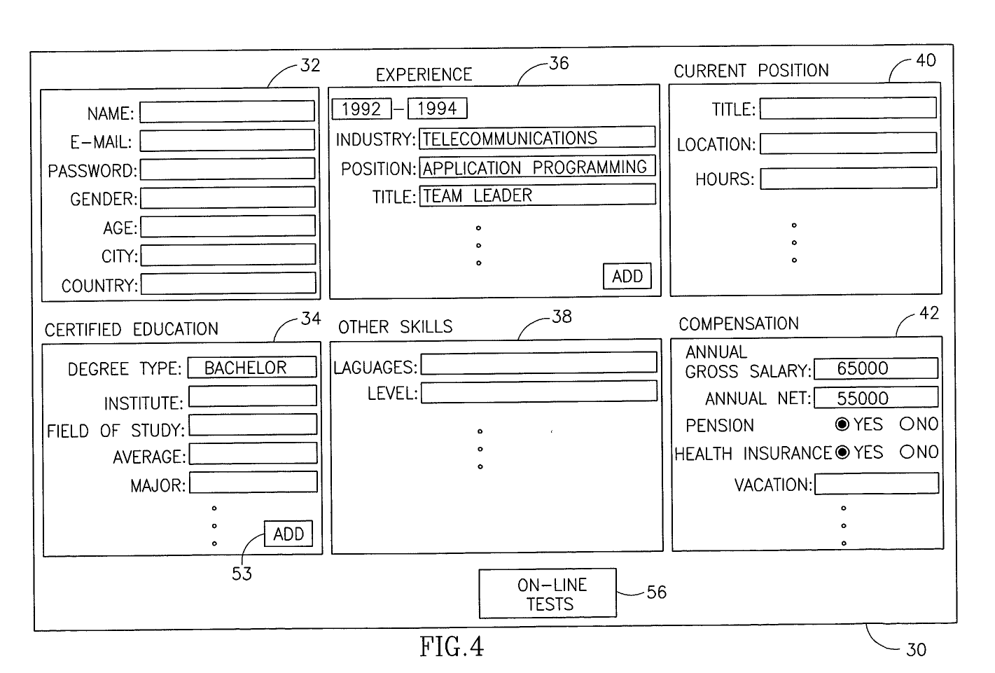

Referring now in more detail to entering (100) the record, the user optionally enters the record information to server 22 from a remote terminal 24, over network 26. Optionally, the user surfs to a Web site of server 22 which contains forms to be filled in by the user, as described hereinbelow with reference to FIG. 4. Alternatively or additionally, the user enters the information on terminal 24 and uploads the record to server 22. Optionally, the user downloads a procedure for entering the information from server 22 to terminal 24. This alternative is especially useful for users who wish to enter information for a plurality of workers. Further alternatively or additionally, the user downloads forms and/or receives the forms by mail or Fax, and returns the forms using mail, e-mail, Fax or any other suitable means. Further alternatively or additionally, the user sends the information to be included in the record in an open format and server 22 translates the information in the open format into the form of the records in the database using text mining and/or by a human operator.

FIG. 4 is a schematic illustration of a Web page 30 for receiving information for the worker database, in accordance with an embodiment of the present invention. Web page 30, which optionally is part of interface 12, comprises a plurality of windows for entering various employment information of a worker. The windows may be displayed on a single page or on a plurality of linked pages. For the simplicity of FIG. 4, all the windows are shown on a single page. Optionally, Web page 30 comprises a personal information window 32 in which the user may enter a name, residence location (e.g., city, state and/or country), e-mail address, and other personal information which may be used to contact the worker and/or the user. In some embodiments, however, users are not obligated to enter identification information and/or may use pseudo names. In some embodiments of the invention, the user receives an internal mailbox on server 22, for example when the user does not have a mailbox or when the user does not want to identify himself. Personal information window 32 optionally also receives general information about the worker, such as age (or birth date), gender and personal status.

In some embodiments of the present invention, Web page 30 comprises an education window 34, an experience window 36, an expertise window 38, a current position window 40, and a compensation window 42. Windows 32, 34, 36, 38, 40 and/or 42 optionally comprise a plurality of fields for entering information as described hereinbelow. Alternatively or additionally, the windows of Web page 30 are organized in any other suitable method, such as hierarchically or like a CV.

Optionally, education window 34 is used to enter the formal education of the user. In some embodiments of the invention, window 34 allows entering a description of a single degree. After entering all the information about the degree the user presses actuates an “add” control 53 and can then use window 34 to add another degree description. Optionally, at a later time server 22 displays the entire user profile so that changes and/or corrections may be made. The fields of window 34 optionally include a field 50 for stating the type of the degree (e.g., high school, bachelor, master, doctorate), the degree major (field of study), a degree emphasis, the institute giving the degree, the average grade of the degree and/or an open description of the degree.

Experience window 36 is optionally used to enter the various jobs carried out by the user. Optionally, for each position filled by the worker, the user selects the industry in which the experience was accrued, the position and the position title. Optionally, if necessary, the user may define new positions and/or position titles. In addition, the user optionally states for each position, the name of the company in which the experience was accrued, the location of the company, the size of the company (e.g., the number of employees in the company), and/or the span of time in which the worker worked for the company. In some embodiments of the invention, the user is requested to enter compensation information for each position stated in experience window 36.

Expertise window 38 is optionally used to enter information on the capabilities of the user, other than those stated in windows 34 and 36. Such information optionally includes, for example, languages and tools the user is familiar with, pros and cons of the user, and other non-certified information about the worker.

Window 40 optionally comprises fields for describing the position in which the user is currently working including the title, company name, geographical location, employment terms, etc. Window 42 optionally comprises fields for entering the salary (gross and/or net) of the user in the current position and other compensation information (bonuses, commissions, vacation days, car, pension plan, health insurance, shares, etc.).

Interface 12 optionally also includes a desired position and compensation window in which the user optionally enters the conditions under which he/she would consider taking on a new position. In some embodiments of the invention, filling in the desired position window is an implicit request to receive notification of new matching job openings received by server 22. In some embodiments of the invention, the user states in the desired position window, the type of work sought, the position sought, the maximal number of monthly hours of the position, a minimum compensation and/or any other job related conditions. Optionally, the user also states preferences relating to the company offering the job, such as a company size, an industry in which the company deals, a company location. The company location is optionally stated in terms of the maximal distance the worker is willing to commute and/or whether the worker is willing to relocate and to where the worker is willing to relocate.

Optionally, information is entered to Web page 30 and/or interface 12 by selection from predetermined lists in order to simplify the comparison between information of different records. Alternatively or additionally, the information entered in some of the fields are single words or phrases such as names which are relatively easy to compare. Further alternatively or additionally, at least some of the fields are filled in free style. Optionally, server 22 applies text parsing methods to the free style fields text to categorize the entered information. Alternatively or additionally, the information in the free style fields is not used in comparing records.

In some embodiments of the invention, Web page 30 includes a control 56 for invoking testing unit 13. The results of the tests from testing unit 13 are optionally directed automatically to the user's record in database 10. Optionally, the user may view the results of the tests performed. In some embodiments of the invention, the user may request to discard the results of the test if a grade of the tests was too low.

In some embodiments of the present invention, each record is associated with a date and/or a range of dates in which the information is valid. Optionally, with the entered information the user states a period in which the information is expected to be valid. At the end of this period server 22 optionally sends an automatic reminder to the user requesting that the user enter updated information. Alternatively or additionally, reminders are sent to the users periodically, for example, every half year. Optionally, the new information is entered in a separate record in the database. Alternatively, the new information is entered in separate fields of the same record as the previously entered information.

In some embodiments of the invention, a user may fill less than all the fields included in a record, for example, when some of the fields are not applicable or when a user wishes not to disclose some information. For example, a user who is unemployed does not fill in windows 40 and 42 which are not applicable. In some embodiments of the invention, the user receives coupons for services of server 22 according to the level of detail of the entered information.

In some embodiments of the present invention, server 22 presents the user with a number of fields to be filled in which matches a patience level of the user for filling forms. Optionally, upon connecting to server 22, the user states the level of detail in which he/she desires to fill out the forms. Alternatively or additionally, server 22 uses the first form provided to the user as a test form which is used to determine the preferences of the user in filling out forms. According to the speed and/or detail level in which the user fills out the test form, server 22 estimates the desired level of detail of the forms provided to the user for filling. In some embodiments of the invention, the level of detail is adjusted also according to the forms which are later presented to the user. Further alternatively or additionally, server 22 receives indication of the level of detail in which the user fills out forms from another server in network 26 which determined the level.

In some embodiments of the invention, a Web page interface for entering job openings, similar to Web page 30 is included in interface 12 (FIG. 2). Alternatively or additionally, interface 12 comprises an automatic agent which gathers employment information from other Internet Web sites. The agent scans through other sites and collects information on job openings and/or worker profiles. In some embodiments of the present invention, a user who searches for a job through database 11 and comes out with one of the openings supplied by the agent is provided with a link to the site where the agent found the opening. Alternatively, server 22 sends a message to the site where the agent found the opening reporting that a user is interested in their job opening and calling the employer to connect to the Web site of server 22.

In some embodiments of the present invention, a scanner is used with OCR software to enter job-openings from newspapers into the database. Alternatively or additionally, the job openings are received directly from the printing press of the newspaper.

In some embodiments of the present invention, each job opening record includes a date in which the record was entered. Optionally, job opening records have a limited life span and expire if their life span is not extended. This is to prevent accumulating job opening records which describe positions which were filled already. Alternatively or additionally, in entering a job opening the user is requested to state a life span of the opening. Further alternatively or additionally, server 22 estimates the life span of the job opening according to the average time it took to fill similar positions. In some embodiments of the invention, an additional database saves old job opening records which have expired.

Optionally, the employer may remove the job opening record at any time, for example when a suitable candidate was found. Optionally, when the employer removes a job opening, server 22 asks the employer to enter a worker profile of the worker who filled the opening.

In some embodiments of the present invention, the user may prepare a home page which represents the qualifications of the worker in a manner chosen by the user. Optionally, a link to this page is included in the user's record within the database. Optionally, server 22 provides the user with tools for building and posting the home page on server 22. In some embodiments of the present invention, server 22 includes a plurality of home page templates which the user may customize. Alternatively or additionally, the user may prepare and/or post the home page on substantially any processor connected to network 26.

In some embodiments of the present invention, the worker is assigned a secret password which is required to perform changes to the home page. Alternatively or additionally, the password is required to view the home page such that only employers who the worker is interested in are allowed to view the home page. In some embodiments of the invention, the worker may create a plurality of different home pages which are displayed to different employers. For example, a first home page may be used to impress employers from large companies and a second home page may be used to impress employers from small companies.

Referring now to the feedback provided (102) by server 22 responsive to the entered record, the feedback is optionally generated automatically by server 22 without human intervention. Thus, the feedback is received within seconds from entering the information. Optionally, server 22 compares the entered record to other records in the worker database in order to generate the feedback. Optionally, those records which are considered similar to the queried record are taken into account in determining the information.

In some embodiments of the present invention, the feedback comprises one or more salary related variables indicative of salaries received by workers with the same or similar profiles as the profile in the record entered by the user. In some embodiments of the present invention, the salary related variables comprise an average of the salaries in the similar records. Alternatively or additionally, the salary related variables comprise a median salary of the similar records, a range of salaries in the similar records, maximal and/or minimal salaries and/or any other value indicative of the salaries in the similar records. Optionally, similar salary related variables may be defined for entire industries.

In some embodiments of the invention, the salary related variables are used in a manner similar to the “Dow Jones” indicator of the stock market. For example, a worker may link his salary to a salary related variable of his/her worker profile. Alternatively or additionally, a worker may check the rate at which the salary related variables of different profiles, different industries and/or different positions change, and accordingly determine which job position to choose.

In some embodiments of the present invention, one or more of the salary related variables represents compensation factors not included in the salary, such as company shares, options and bonuses, pension plans, health insurance, car use from the employer and vacation and sick days. In some embodiments of the invention, the factors not included in the salary are displayed and/or averaged separately from the salary. Alternatively or additionally, one or more composite variables summarize in one number all the factors not included with the salary together with the salary. In some embodiments of the invention, the user may define an equation used to summarize the compensation factors and/or may use one or more predefined equations. In some embodiments of the invention, users may supply server 22 with equation definitions which are believed to be of interest to many users. The user optionally is allocated benefits from server 22 according to the number of users which use the definition. In some embodiments of the invention, supplementary information on the overhead costs of employment in various geographical areas, is used to generate a composite salary value which indicates the total cost of the worker to the employer and/or the total revenue received by the worker.

In some embodiments of the present invention, the supplementary information includes information on the average cost of living in various geographical areas. In displaying average compensation information from various geographical locations, server 22 optionally displays therewith information on the cost of living in those places. The cost of living information optionally includes tax levels, housing costs, transportation costs and other costs.

In some embodiments of the invention, server 22 displays a graph which shows one or more of the salary related variables as a function of one or more of the fields of the records. Optionally, the user can select the one or more variables displayed and/or the one or more fields on which the graph depends. In some embodiments of the invention, the user may choose the type of the graph, from a list of graph types, optionally including pie charts, histograms, x-y graphs three dimensional graphs, etc. The fields on which the graph depends may be, for example, geographical area, age of worker, experience and/or substantially any other fields in the databases of server 22.

In some embodiments of the invention, server 22 displays one or more of the salary related variables as a function of time. Optionally, server 22 states whether the salaries of records similar to the entered profile are stable, increase or fluctuate with time. In some embodiments of the invention, server 22 states the percentage at which the salary changed in a predetermined previous interval (e.g., a previous quarter). Thus, a worker may determine whether to sign a long term or short term contract with an employer.

In some embodiments of the invention, salaries from all over the world are stored in the database in a single currency, e.g., the dollar. Alternatively, the salaries are stored in the database in the local currency in which they are paid. The supplementary information optionally includes updates of the going exchange rates of the currencies. Optionally, server 22 displays the salaries in the local currency in which they are paid and/or in any currency according to the choice of the user. In some embodiments of the invention, instead of, or in addition to, using the current exchange rate in displaying salaries, an average exchange rate or a range of exchange rates is used.

In some embodiments of the invention, along with the query results, server 22 states one or more statistical measures of the results. For example, along with an average salary, server 22 optionally displays the standard deviation of the results and/or the percentages of workers who fall within different salary ranges. In some embodiments of the invention, server 22 states the number of worker records from database 10 which are similar to the entered record and/or the number of positions from job database 11 which match the entered record.

In some embodiments of the present invention, the feedback includes suggestions to improve the worker's profile. The suggestions optionally include cosmetic clarifications, such as suggesting using the term ‘sanitary worker’ instead of ‘cleaner’ and/or actual changes which require additional studies and/or other activities of the user. In some embodiments of the invention, server 22 provides along with the suggestions links to Internet sites of institutes which supply the additional studies suggested to the user.

In some embodiments of the invention, the feedback indicates required changes in the profile which lead to an increase of a certain percent in the worker's salary. Alternatively or additionally, a user may request to know what changes in the profile are required to reach a specific position (e.g., department manager) or one of a predefined group of positions and/or what salary the worker would receive in that position. Alternatively or additionally, the feedback includes the skills which are useful for the worker in finding a high salary job in a specific location. In some of these embodiments, the user may indicate fields in which changes are not wanted or may limit the extent of changes in certain fields.

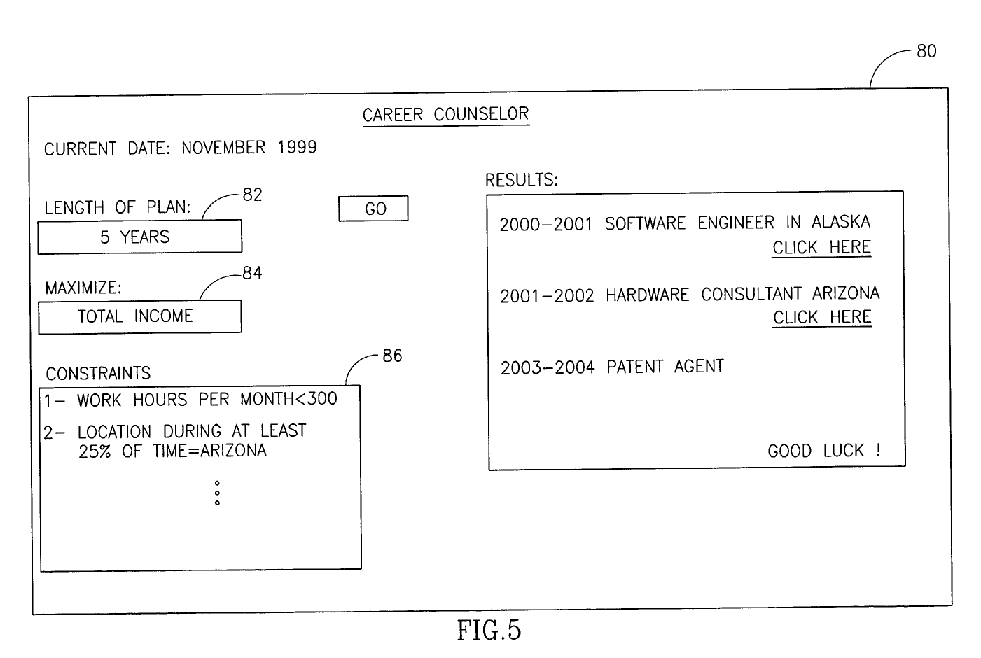

FIG. 5 is a schematic illustration of a user interface 80 for career counseling, in accordance with an embodiment of the present invention. In some embodiments of the invention, the feedback comprises a career plan which is based on the entered record describing the worker profile. The career plan optionally suggests positions and courses which the worker should take in years ahead in order to maximize one or more desired attributes. Optionally, the user enters in a field 82 the number of years to be included in the career plan. In addition, the user optionally states in a window 84 one or more attributes which are to be maximized, such as the accumulated salary over the entire planned period or the salary at the end of the planned period.

In determining the career plan, server 22 optionally takes into account the increasing experience of the user over the period of the plan. In addition, server 22 optionally estimates changes in salaries expected in the future. In some embodiments of the invention, the supplementary information in server 22 includes trends in worker needs based on expected shortages and surpluses of workers. The trends in worker needs can be determined based on the numbers of students which educational institutes take in, on the average graduation rates of the institutes, and on current and expected investments in education institutes. Further information used to determine the trends in worker requirements are the developments in the relevant industries.

In some embodiments of the present invention, the trends in worker needs are partially or entirely determined from the databases carried by server 22. Optionally, the rate at which the salaries of certain workers increase, the rate at which job openings are filled, and/or the changes in the numbers of workers in certain fields are used to estimate the salaries in certain industries in the future. Alternatively, the trends in worker needs are determined irrespective of the contents of the databases carried by server 22.

Optionally, a window 86 is used to state constraints on the career plan. For example, the user may require that during at least half of the period the user's residence will be in Arizona. In another example, the user may define a maximal (or minimal) number of job transitions which the user will undergo.

In some embodiments of the invention, the career plan is compared to the previous experience of the worker, indicating, for example, whether the worker is to expect a higher or lower rate of progress.

In some embodiments of the present invention, the career planning may be used by students directly out of high school who wish to determine where to study. In this embodiment, server 22 optionally carries in the supplementary information a database of tuition fees for various universities and these fees are taken into account in planning the career. It is noted that workers may receive different salaries based on the universities in which they studied.

In some embodiments of the present invention, the cost of living and/or quality of living measures are taken into account in preparing the plan. In some embodiments of the present invention, the going interest rate is taken into account in order to give proper weight to the salaries received in different years along the planned period.

In some embodiments of the invention, the feedback information comprises indication of the rate at which workers having the queried profile change jobs. This information may be determined from the experience fields entered to the database as well as from the updating performed by the users.

In some embodiments of the present invention, the user may download to terminal 24 some or all of the fields of the records which are similar to the entered record. Optionally, on terminal 24 the user may manipulate the records using any database software known in the art.

In some embodiments of the invention, server 22 charges a sum for each downloaded record and/or limits the total number of records allowed to be downloaded by a user.

In some embodiments of the present invention, the feedback information is based on the job-opening database in addition to, or instead of, being based on the worker database. For example, the average salary may be determined based on the salaries offered in job opening records which match the user profile. Optionally, the user may select the database or databases used in generating the feedback information.

In some embodiments of the invention, the user may request additional information based on variations of the entered record. Optionally, the user may provide server 22 with “what if” questions (104) which deal with variations of one or more fields of the entered records. For example, after receiving indication of the average salary of workers which have a profile similar to the entered record, the user may ask what would be the salary of the worker if he/she had an additional degree or had additional experience.

In some embodiments of the present invention, the user may state one or more fields which are changeable in the entered record, and server 22 states a list of several (e.g., five) top values of the fields which achieve a highest salary. For example, the user may state that the location is changeable and receive a list of several locations in which a worker with a similar profile (except the location) have the highest salaries.

In some embodiments of the present invention, server 22 carries an additional database in which queries are stored. The information in the query database may be used to supplement the other databases in determining trends in employment related issues. For example, it is possible to determine from the queries which are based on variations of entered profiles, which fields are considered by workers and/or employers as open for changes.

In some embodiments of the invention, the user may provide queries which are totally unrelated to an entered record. For example, an employer may be interested in the going cost of certain workers in order to decide whether to go through with a future project. In such a case, there is no reason to store the details of the fictitious job-opening in the job-opening database.

In some embodiments of the present invention, users may query the database for general information unrelated to a specific job-opening or worker. For example, statistics may be determined on the average compensation of different groups of workers according to their professions, nationality, age and/or other parameters. Optionally, a user may request to know the number of records in the database which have specific values in one or more fields. For example, a user intending to take a specific course may wish to determine how many job openings list such type of a course as a requirement or an advantage. In another example, a user may request to know the job-positions which workers with a specific education occupy.

In some embodiments of the invention, the general information provided by server 22 comprises information on trends over time in employment issues. For example, users may query for the rate of change of salaries in certain positions, industries and/or locations.

Optionally, any of the queries described above relating to a specific profile may be asked in general terms by providing a blank profile or a semi-blank profile in which most of the fields may receive substantially any value.

Referring back to displaying job openings (108), server 22 optionally automatically searches through the job-openings database for job-openings which fit to the profile of the user. For each job opening, server 22 optionally displays a description of the job, a description of the requirements to fulfill the position, the date at which the job opening was entered to database 11, the company offering the job and the offered salary. Alternatively, the description does not include the requirements to fulfill the position as the worker matches the requirements. In some embodiments of the present invention, the company name and/or a contact number are displayed only for a payment from the user.

Optionally, server 22 displays the matching job-openings together with a score which is indicative of the similarity between the profile and desires of the user and the description of the job opening.

In some embodiments of the present invention, each job opening is displayed with an indication on the attitude of the employer towards the worker. In some embodiments of the invention, the employer attitude is one of three possibilities, i.e., the worker does not fit the employers requirements and therefore the worker did not appear in the employers search, the employer saw the worker's profile in search results, and the employer asked for more information about the worker. In another embodiment, an additional possibility is used to state that the employer specifically asked the worker to form contact with the employer.

In some embodiments of the invention, employers are charged for placing interest indications on worker profiles. In some embodiments of the invention, employers may pay additional fees for having their job opening records displayed in bold, at the top of a workers list, or with any other emphasis or attached advertisement. Optionally, the emphasis or advertisement is displayed for all workers for which the job opening appears in a search. Alternatively, the emphasis or advertisement is displayed for workers selected by the employer. Further alternatively or additionally, the emphasis or advertisement is displayed for workers selected automatically according to rules defined by the employer. For example, the emphasis or advertisement may be for workers with a certain level of experience or degree only, and other workers will see a regular display of the job opening.

In some embodiments of the invention, the colors of the displayed job openings ate used to indicate the employers attitude. For example, black matches (i.e. job opening descriptions displayed in black) indicate that the worker did not appear in the employer's search, blue matches indicate that the worker appeared in the employers search, and red matches indicate that the employer requested more information about the worker. In some embodiments of the invention, employers may choose whether they want their job-openings displayed as blue matches. Thus, employers can prevent being flooded by worker applications which are irrelevant.

It is noted that in some embodiments of the invention, workers do not have to enter their e-mail address or any other way they me be contacted. Therefore, the contact between an employer and a worker is optionally initiated by the worker. In some embodiments of the invention, the worker enters a profile to database 10. After a desired time, e.g., a week, the user returns to server 22 to search for job openings. The search results optionally include indication of the attitude of the employers as described above, which was gathered during the time since the profile was entered. Alternatively or additionally, server 22 sends updates, e.g., via e-mail, with search results.

In some embodiments of the invention, when displaying job openings (108), server 22 displays information on the cost of living in the location of each job opening. Alternatively or additionally, server 22 displays with the job openings description of residence areas near the location of the job, real estate prices, traffic information in the location, climate information, crime rate descriptions and/or other environmental information regarding to the location. Further alternatively or additionally, server 22 supplies links to other databases which display information related to the location, such as real estate databases.

In some embodiments of the present invention, the matching job-openings are displayed with a link to Web sites of the companies offering the job-openings so that the user may get an idea about the company. Alternatively or additionally, the job-openings are displayed with one or more links to pages which describe the companies offering the job-openings in Web sites which describe companies. For example, one of such sites may comprise a site which describes the status of companies in the stock market and/or an analysis of the future of the company. Further alternatively or additionally, the matching job-openings are displayed with links to former and/or present workers of the company which are willing to discuss their work in the company.

In some embodiments of the present invention, server 22 helps the user in comparing between job offers. Optionally, upon receiving a listing of matching job-openings, the user selects some or all of the job-openings which are of interest and requests that server 22 compare the selected job-openings. Server 22 optionally displays a list of the parameters which differentiate between the job-openings and requests that the user give weights which designate the importance of the parameters in the user's decision. Accordingly, server 22 optionally rates the job-openings for the user. For example, the user may be presented with two similar job-openings one from a small start-up company and another from a large company. Server 22 will show the user the difference between the job offers and request that the user decide if to apply to a small firm or to a large firm.

In some embodiments of the present invention, the supplementary information includes information useful in helping users to decide between job-openings. For example, server 22 optionally carries articles which argue for and against issues which differentiate between job-openings. For example, server 22 optionally carries articles which list the advantages and disadvantages in working in large firms.

Alternatively or additionally, server 22 carries Web pages in which employees describe and/or rate their employers. Further alternatively or additionally, server 22 carries suggestions for negotiating with particular companies and/or descriptions of interviews in various companies.

In some embodiments of the invention, as described above relating to receiving feedback, the user may perform job opening queries which are based on variations of the entered record and/or queries totally unrelated to the entered record. Such additional queries may be used by the user to determine what additional studies and/or experience he/she should acquire.

As described above (106), the user may amend the entered record responsive to the feedback information and/or the displayed job openings. Optionally, the user may amend any of the fields of the entered record. The possibility to amend is especially useful for the desired position and compensation information. For example, if the user learns from the feedback that the entered desired salary was too high or too low in order to receive relevant job offers, the user may amend the desired salary. In addition, some skills may be stated in two different equivalent ways and the user may determine which is better for his/her purposes.

In some embodiments of the present invention, a user returning to the Web site of server 22 at a later time may request to view only job-openings which he/she did not see in previous visits to the Web site. Alternatively or additionally, the user may request to view job openings for which some of the parameters changed, such as the offered salary, and/or job openings which are very old and the employer may have become desperate.

Reference is now made in more detail to job opening database 11. In some embodiments of the present invention, there is a one to one correlation between the fields in the database of job openings and the fields in the workers database. The job opening database optionally includes for each record one or more fields in some or all of the categories: employer information, required education, required experience, required expertise, offered position and offered compensation. Optionally, the records may include ranges, in some of the fields, such as a range of the required number of years of experience. Alternatively or additionally, the records indicate an importance of the requirement. For example, some of the requirements are obligatory requirements and others are advantageous requirements. Alternatively, the requirements are graded along a scale of multiple values. In some embodiments of the present invention, records may state a plurality of different levels for fulfilling the requirements. Thus, an employer may state that in a high preference the required education is a doctorate from a top level institute, and in a lower preference a bachelor degree will suffice. Alternatively or additionally, the records may indicate alternative combinations of education, experience and expertise which suit the job.

In some embodiments of the present invention, server 22 helps employers in formulating their requirements. Optionally, the employer enters a position description and/or a salary range and server 22 suggests requirements for such position, based on other job-opening records, other worker records and/or previous job openings posted by that employer. Optionally, the employer may change the requirements according to his/her preferences. In some embodiments of the invention, server 22 determines for a specific position whether it is worthwhile to hire a single worker or two workers. For example, the single worker may be of high quality and/or a full time worker and the two workers may be of lower quality and/or part time workers.

In some embodiments of the present invention, server 22 asks workers entering profiles to database 10 whether their education and/or experience are useful in their current position. Optionally, server 22 asks the workers what additional education and/or experience would best suit their position. This information is optionally used in helping employers to formulate job opening records.

In some embodiments of the present invention, in describing a job-opening an employer may state the offered salary as a function of the qualifications of the worker. Thus, different users will be displayed the same job-opening with different salaries according to their qualifications. In some embodiments of the invention, the user is not notified that the description of the job opening depends on the worker's qualifications.

Optionally, responsive to entering a job opening record, an employer may search the worker database for workers who fit the job opening. In some embodiments of the present invention, the employer is presented short records defining workers who match the job opening. The employer optionally must pay an additional sum in order to view the full record and/or another sum in order to receive the personal details of the worker (e.g., an email address).

In some embodiments of the invention, responsive to entering a job opening record, an employer may query the database for feedback information. For example, an employer may query the database for the salary which he/she should offer for the entered job opening. The information may be received from the job opening database and/or from the worker database. The searching and querying are optionally performed in a manner similar to that described above in relation to querying responsive to entering a worker profile.

In some embodiments of the invention, all the possibilities described above with reference to worker database 10 are applicable to job opening database 11. For example, the employer optionally may also query based on variations of the entered record and/or without relation to an entered record. Likewise, the employer may optionally leave delayed queries to be handled at later times, periodically and/or when additional records are entered to the database. Furthermore, an employer may optionally receive feedback information, such as the going salary rate of workers having a certain profile. Optionally, the employer may also query for the changes required in a job opening profile in order to reduce the employment costs by a certain percent.

In some embodiments of the invention, searching for workers is not necessarily performed by presenting a job opening description. In some cases an employer wishes to find a replacement for a worker which the employer was satisfied with. In such a case the employer may enter the description of the worker and search for workers with similar profiles. Similarly, a worker may search for a job in the job database by providing a description of a job opening he/she was satisfied with and searching for a similar job opening.

Searching for workers with similar profiles may also be used to found clubs and worker's unions.

In some embodiments of the invention, the user defines the meanings of similarity of records in the same database and/or of matching of records of different databases. In some embodiments of the invention, for each field of the records of the database the user states a maximal distance between values which are considered the same and/or lists equivalent values. For example, the user may state that for a field stating a job location a distance of up to 60 kilometers between two places is considered similar. In another example, the user may state which academic degrees are to be considered similar. For example, the user may state that a degrees in computer engineering and physics are similar for a certain query. In some embodiments of the invention, the user may define for some of the parameters equivalence groups and/or give ratings to values of the parameters. For example, educational institutes may be graded and/or grouped according to the prestige of the degrees they give.

In some embodiments of the invention, the user states the maximal number of non-similar fields allowed in similar records. Optionally, the user also states which fields must have similar or identical values.

Alternatively or additionally, the user states for at least some of the fields weights of the importance of their having similar values. Optionally, the weight of a field may depend on the absolute and/or relative values of the compared fields or may be assigned irrespective of the values of the compared fields. Optionally, records are considered similar or matching if they receive a similarity score, based on the weights, above a predetermined threshold. Optionally, the user may move the threshold in order to receive more or less results.

Alternatively or additionally to the user defining the meanings of similarity and matching, server 22 carries one or more default definitions for similarity and/or matching and the user selects a default which best suites his/her needs. Server 22 optionally carries also partial definitions such as gradings and/or ratings of one or more specific fields. For example, server 22 may carry a plurality of different gradings of fields of the database, such as educational institutes, based on opinions of different experts. The user optionally chooses the default definition of an expert which the user trusts the most. In some embodiments of the invention, the predefined defaults, define a rigid definition which requires precise matching, a lenient definition which allows for relatively large discrepancies and a medium definition which allows small discrepancies.

Further alternatively or additionally, the user states a number of similar records, or a category of the number (e.g., few, medium, many), of records which are to be considered similar. Accordingly, server 22 sets the definitions of what is considered similar to achieve that number of similar records.

In some embodiments of the invention, the user may state periods from which records are considered similar and/or matching. For example, the user may request to use only recent data or data from a specific date range in generating the feedback.

Optionally, the user may perform a plurality of queries and/or searches using different definitions until a suitable listing of job openings and/or feedback data is received.

In some embodiments of the present invention, server 22 manages chat rooms in which employers and workers may talk. Optionally, the chat rooms are divided according to professions. Alternatively or additionally, the chat rooms are divided according to other attributes, such as geographical areas (with a special chat room for “work from home” jobs), salaries and education. In some embodiments of the invention, the entrance to the chat rooms is unrelated to entering information and/or querying the databases. Alternatively, chat rooms are opened for workers and employers who have matching profiles. For example, a notification may be sent to all the employers that entered job-openings that match the profile of a worker that the worker will answer questions in a specific chat room at a specific time. Conversely, all the workers who fit a certain job may meet with the employer in a chat room. Alternatively or additionally, multi-employer multi-worker meetings may be worked out for closely related job-openings. Further alternatively or additionally, an employee and candidate may meet in a private chat room and/or on a direct Internet telephony call.

In some embodiments of the invention, when a worker and employer discuss the salary the worker is to receive, the employer and worker may consult server 22 for the going rate of workers with the profile of the worker. Optionally, server 22 shows a listing of the most similar cases and accordingly suggests a salary. In some embodiments of the invention, server 22 finds pairs of records which differ in the same manner in which the worker record differs from the most similar case and accordingly suggests the salary.

In some embodiments of the present invention, chat rooms may be used to auction off job-openings and/or workers in live auctions. Optionally, after a sufficient number of employers show interest in a worker (or workers show interest in a job opening), a time is set for a live auction in a chat room, and the relevant employers are notified (e.g., using e-mail). Optionally, in entering the auction chat room each employer signs an agreement not to employ the worker if he/she does not win the auction.

In some embodiments of the present invention, a charge is required for some or all of the services provided by server 22. In some embodiments of the invention, free queries are allotted to users who provide information to the database. Alternatively or additionally, searches which require entering data are provided for free, while searches which do not require entering data are provided for a fee. Thus, users are encouraged to enter correct information. In some embodiments of the present invention, services which are given for a fee include placing personal home pages larger and/or longer than a minimal standard,

In some embodiments of the invention, a user who entered a record describing a worker profile to the worker database is entitled to search job opening database 11 for jobs matching the worker profile. Similarly, an employer entering a job opening description to job opening database 11 is entitled to search for workers who match the job opening description. A fee is optionally required for queries which require changes in the profile. In some embodiments of the invention, server 22 does not provide answers to queries which differ beyond a predetermined number of fields from the entered information in order to prevent information leakage from databases 10 and 11. Alternatively or additionally, server 22 charges for queries based on the extent of the difference between the query and the entered profile.

In some embodiments of the present invention, server 22 evaluates the truthfulness and/or detail depth of the information entered by the user and accordingly allots an amount of free queries to the user. Alternatively or additionally, users which provide their true identity and/or agree that the information they provide be passed on a commercial basis are provided with a free amount of queries.

In some embodiments of the present invention, the quality of the feedback and/or the speed at which the user receives notification of workers, job-openings and/or data feedback depends on the amount of money paid by the user.

In some embodiments of the invention, the urgency in which the employer receives notification of the worker which fits the description depends on the amount of money paid by the employer. For example, for a small fee the employer is updated once a week, or a week after the worker subscribes to the database, and for a higher fee the employer gets notification within an hour from when the worker subscribes to the database. In some embodiments of the invention, employers paying high fees are given immediate notice of the new workers and the addition of the record of the worker to the database is delayed for a predetermined amount of time (e.g., an hour) to allow these employers a head start in recruiting the worker. In some embodiments of the present invention, upon receiving immediate response from an employer to an entered worker profile the user entering the worker profile is displayed a control which forms immediate contact with the employer.

In some embodiments of the present invention, the results of a search for workers are displayed without the personal information of the worker such that the employer cannot contact the worker without requesting the personal information. In some embodiments of the invention, the employer pays the operator of server 22 a predetermined sum for each listing of personal information. Optionally, the sum paid for the personal information is dependent on the quality of the worker. In some embodiments of the invention, a portion of the paid sum is passed to the worker, optionally in the form of free information from server 22.

Alternatively or additionally, in order to receive the personal information the employer must agree that if he/she employs the worker, a fee will be paid to the operator of server 22. Further alternatively or additionally, the employer places a bid for receiving the personal information and the employer who places a highest bid receives the information. In some embodiments of the present invention, an employer is given the details of only one worker at a time and additional details are given only after the employer pays for the previously received details

Alternatively or additionally to receiving the personal information, the employer places a bid for employing the worker, for example, by offering a salary. In some embodiments of the present invention, the bids are offered using e-mail messages. The employer who places the highest bid is optionally given a first chance to interview the worker.

In some embodiments of the present invention, a routine is periodically run on worker database 10 weeding out records which are obviously incorrect.

In some embodiments of the invention, server 22 has the feature that it keeps neutral between the workers and employers.

In some embodiments of the present invention, upon a user's request the server prepares a CV based on the entered profile of a worker. Optionally, the user may select a template for the CV from a plurality of templates available on server 22. Optionally, The CV includes a reference to the Web site on server 22.

In some embodiments of the present invention, advertisements are sent to workers based on their job profiles. For example, advertisements for luxuries may be sent to people with high salaries. Alternatively or additionally, workers are sent advertisements about courses which may raise their salaries significantly. The advertisement may state the average raise in salary the worker is expected to get on the time in which the investment pays back.

It is noted that the above described embodiments which were described with relation to the worker database may be employed for the job-opening database, and those embodiments described with respect to the job opening database apply also to the worker database.

It will be appreciated that the above described methods may be varied in many ways, including, changing the exact implementation used and using ideas relating to the worker database for the job-opening database and vice-versa. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features described with respect to one embodiment may be used with other embodiments and that not all embodiments of the invention have all of the features shown in a particular figure. Variations of embodiments described will occur to persons of the art. Furthermore, the terms “comprise,” “include,” “have” and their conjugates, shall mean, when used in the claims, “including but not necessarily limited to.” The scope of the invention is limited only by the following claims:

1. A method of job placement, comprising:
storing a database including a plurality of records of job openings;
providing a worker record which includes one or more fields describing a worker and one or more fields describing a position desired by the worker; and
automatically determining by a processor, for at least one of the records in the job opening database, whether the job opening in the record matches the position desired by the worker and whether the worker description matches the job opening in the record.

2. A method according to claim 1, comprising displaying data from one or more records of the job opening database which were determined to match the position desired by the worker and to which the worker description matches.

3. A method according to claim 2, wherein displaying the data from one or more records comprises displaying each record along with an indication of an attitude of an employer generating the job opening record toward the worker record.

4. A method according to claim 3, wherein the indication of the attitude of the at least one employer comprises an indication of whether the description of the worker was viewed by the at least one employer.

5. A method according to claim 1, wherein the one or more fields describing a position desired by the worker comprises a field which states a salary range desired by the worker.

6. A method of job placement, comprising:
storing a database including a plurality of records of worker profiles;
providing a description of a job opening;
storing the description of the job opening in a job opening database; and
automatically determining by a processor, for at least one of the records in the worker database, whether the worker profile in the record matches the description of the job opening.

7. A method according to claim 6, comprising automatically providing by the processor suggested changes in the description of the job opening such that the description matches a desired set of one or more records.

8. A method according to claim 6, wherein storing the worker database comprises storing a database in which at least some of the records include a salary received by the worker represented by the record.

9. A method according to claims 6, wherein storing the worker database comprises storing records which include values for a predetermined set of fields and providing the description of the job opening comprises providing values for fields compatible to the predetermined set of fields.

10. A method according to claim 9, wherein providing the description of the job opening comprises providing range values for one or more of the compatible fields.

11. A method according to claim 9, wherein providing the description of the job opening comprises stating a level of importance for one or more of the compatible fields.

12. A method according to claim 6, wherein determining for at least one of the records whether the worker profile in the record matches the job opening description comprises determining which of a plurality of the records match the job opening description.

13. A method according to claim 12, comprising providing a list of the workers represented by the matching records to an employer.

14. A method according to claim 13, comprising selecting by the employer workers who are of interest to the employer, and indicating to the selected workers that they have been selected by the employer.

15. A method according to claim 14, wherein indicating to the selected workers comprises marking a job opening description of the employer with a special indication in displaying lists of job opening descriptions to the selected workers.

16. A method according to claim 12, comprising determining one or more attributes which differentiate between the matching records and displaying a graph which shows an average salary of the matching records depending on the one or more attributes.

17. A method according to claim 6, wherein determining for at least one of the records whether the worker profile in the record matches the job opening description comprises selecting a predetermined number of records which most closely match the job opening description.

18. A method according to claim 6, wherein determining for at least one of the records whether the worker profile in the record matches the job opening description comprises setting a similarity range to the job opening description such that records falling in the similarity range are considered matching the job opening description.

19. A method according to claim 6, comprising providing a different description of a job opening responsive to the determination and repeating the determining with the provided different description.

20. A method according to claim 19, wherein the descriptions of the job openings in the job opening database comprise a plurality of fields and wherein the different description of a job opening is different from the previously provided description in substantially only one field.

21. A method according to claim 6, comprising displaying data from one or more worker records which were determined to match the job opening description.

22. A method according to claim 21, comprising notifying the workers represented by the one or more records from which data was displayed that the data was displayed.

23. A method of establishing an opinion on a worker profile, comprising:
receiving a worker profile;
comparing the received worker profile to a database of a plurality of worker profiles; and
automatically generating by a processor, responsive to the comparison, an opinion on the received worker profile.

24. A method according to claim 23, wherein generating the opinion comprises generating an opinion on a salary level of the received worker profile.

25. A method according to claim 23, wherein generating the opinion comprises generating a career plan for an owner of the received worker profile.

26. A method according to claim 23, wherein generating the opinion comprises suggesting one or more subjects to be studied.

27. A method according to claim 23, wherein generating the opinion comprises stating salary levels for several values of a field of the received worker profile which achieve highest salary levels among the possible values of the field.

28. A method according to claim 23, comprising periodically generating a follow up opinion and notifying a worker represented by the worker profile when the follow up opinion has results substantially different than previously generated opinions.

29. A method of displaying job information, comprising:
storing a database including a plurality of records of job openings;
providing a worker record which includes one or more fields describing a worker; and
displaying information from one or more job opening records which match the worker record along with an indication of the attitude of an employer generating the record toward the worker description.

30. A method according to claim 29, wherein displaying the information comprises displaying information from at least one record along with an indication that the record was viewed by the employer.

31. A method according to claim 29, wherein displaying the information comprises displaying information from at least one record along with an indication that the employer is interested in meeting the worker.

32. A method according to claim 29, wherein displaying the information comprises displaying information in different colors according to the attitude of the employer.
